(19) United States
(12) Patent Application Publication
(10) Pub. No.: US 2022/0215770 A1
(43) Pub. Date: Jul. 7, 2022

(54) INFORMATION PROCESSING SYSTEM, INFORMATION PROCESSING APPARATUS, AND INFORMATION PROCESSING METHOD

(71) Applicant: Cookpad Inc., Kanagawa (JP)

(72) Inventors: Jun HARASHIMA, Kanagawa (JP); Rie TSUDA, Kanagawa (JP)

(73) Assignee: Cookpad Inc., Kanagawa (JP)

(21) Appl. No.: 17/701,707

(22) Filed: Mar. 23, 2022

Related U.S. Application Data
(63) Continuation of application No. PCT/JP2020/028722, filed on Jul. 27, 2020.

(30) Foreign Application Priority Data
Sep. 30, 2019 (JP) 2019-178194

(51) Int. Cl. G09B 5/02; G09B 19/00

(52) U.S. Cl. CPC G09B 5/02; G09B 19/003

(57) ABSTRACT

An information processing apparatus 100 has a configuration that includes: an information holding unit 110 that holds correspondence information 114 that defines a relation between attributes of a person and a difficulty level of respective dishes, and recipe information 112 for the respective dishes; and an estimation unit 120 estimates a difficulty level of the recipe information for a user of the recipe information by applying attributes of the user and information pertaining to a dish to be cooked using the recipe information to the correspondence information 114.

### CROSS-REFERENCE TO RELATED APPLICATIONS

This application is a Continuation Application of No. PCT/JP2020/028722, filed on Jul. 27, 2020, and the PCT application is based upon and claims the benefit of priority from Japanese Patent Application No. 2019-178194, filed on Sep. 30, 2019, the entire contents of which are incorporated herein by reference.

### TECHNICAL FIELD

The present disclosure relates to an information processing system, an information processing apparatus, and an information processing method.

### BACKGROUND ART

In recent years, services that provide cooking recipe information to users via networks such as the Internet are increasing.

For example, Japanese Patent Laid-Open No. 9-034871 discloses an electronic menu creation apparatus that, when a search condition is specified, extracts a dish name that matches the search condition as a dish candidate. In this electronic menu creation apparatus, when the ingredients cost is specified as an arrangement condition, dish candidates are displayed in an order that is based on the ranking of the ingredients cost, when the difficulty level is specified as the arrangement condition, dish candidates are displayed in an order that is based on the ranking of the difficulty level, when the cooking time is specified as the arrangement condition, dish candidates are displayed in an order that is based on the cooking time, and when the amount of ingredients used is specified as the arrangement condition, dish candidates are displayed in an order that is based on the amount of ingredients used.

However, according to the technology disclosed in Japanese Patent Laid-Open No. 9-034871, there is the problem that, for each dish name, a difficulty level of the cooking work (hereinafter, also referred to as “cooking difficulty level”) must be stored in advance. Further, even if the recipe creator sets and registers the difficulty level of the cooking work in this way, the difficulty level is based on the subjectivity of the recipe creator, and it is unclear whether the appropriate setting accuracy is guaranteed.

On the other hand, from the viewpoint of the users of such recipes, there are cases where a considerable discrepancy arises between the difficulty level as considered by the recipe creator and the difficulty level for the user. That is, even if a recipe creator who has a lot of cooking experience thinks that a certain dish is very simple and the difficulty level is low, there is a high possibility that the dish will be seen as having a high level of difficulty in the eyes of a cooking beginner.

Furthermore, the difficulty level for each recipe user can vary not only due to the cooking experience of the recipe user but also due to various other attributes. In other words, unless the cooking difficulty level of each recipe is estimated for each recipe user by taking into consideration the standpoint of each user, ultimately a situation will arise in which it will be difficult to avoid the aforementioned discrepancy with regard to the difficulty level.

### BRIEF DESCRIPTION OF DRAWINGS

FIG. 1 is a configuration diagram illustrating an outline of an information processing system according to an embodiment of the present disclosure.

FIG. 2 is a block diagram illustrating the configuration of the information processing apparatus according to an embodiment of the present disclosure.

FIG. 3 is a view illustrating a configuration example of user information according to an embodiment of the present disclosure.

FIG. 4 is a view illustrating a configuration example of recipe information according to an embodiment of the present disclosure.

FIG. 5 is a view illustrating a configuration example of comment information according to an embodiment of the present disclosure.

FIG. 6 is a view illustrating a configuration example of correspondence information according to an embodiment of the present disclosure.

FIG. 7 is a view illustrating a configuration example of correspondence information according to an embodiment of the present disclosure.

FIG. 8 is a view illustrating a configuration example of compatibility information according to an embodiment of the present disclosure.

FIG. 9 is a flowchart for describing operations of the information processing system according to an embodiment of the present disclosure.

FIG. 10 is a view illustrating an output example according to an embodiment of the present disclosure.

FIG. 11 is a view illustrating an output example according to an embodiment of the present disclosure.

FIG. 12 is a view illustrating an output example according to an embodiment of the present disclosure.

FIG. 13 is a flowchart for describing operations of the information processing system according to an embodiment of the present disclosure.

FIG. 14 is a view illustrating an output example according to an embodiment of the present disclosure.

FIG. 15 is a flowchart for describing operations of the information processing system according to an embodiment of the present disclosure.

FIG. 16 is a schematic block diagram illustrating the configuration of a computer according to an embodiment of the present disclosure.

### DESCRIPTION OF EMBODIMENTS

The present embodiment is described below. Note that the present embodiment described hereunder does not unduly limit the contents of the present disclosure described in the claims. In addition, not all of the configurations described in the present embodiment are necessarily essential configuration requirements of the present disclosure.

An information processing system of the present disclosure includes: an information holding unit that stores correspondence information that defines a relation between attributes of a person and a difficulty level of respective dishes, and recipe information for respective dishes; and an estimation unit that estimates a difficulty level of the recipe information for a user of the recipe information by applying attributes of the user and information pertaining to a dish to be cooked using the recipe information to the correspondence information.

Further, an information processing apparatus of the present disclosure includes: an information holding unit that stores correspondence information that defines a relation between attributes of a person and a difficulty level of respective dishes, and recipe information for respective dishes; and an estimation unit that estimates a difficulty level of the recipe information for a user of the recipe information by applying attributes of the user and information pertaining to a dish to be cooked using the recipe information to the correspondence information.

Further, an information processing method of the present disclosure is a method in which an information processing apparatus holds correspondence information that defines a relation between attributes of a person and a difficulty level of respective dishes, and recipe information for respective dishes, and estimates a difficulty level of the recipe information for a user of the recipe information by applying attributes of the user and information pertaining to a dish to be cooked using the recipe information to the correspondence information.

Further, a program of the present disclosure is a program that causes an information processing apparatus to hold correspondence information that defines a relation between attributes of a person and a difficulty level of respective dishes, and recipe information for respective dishes, and to execute processing that estimates a difficulty level of the recipe information for a user of the recipe information by applying attributes of the user and information pertaining to a dish to be cooked using the recipe information to the correspondence information.

### Configuration

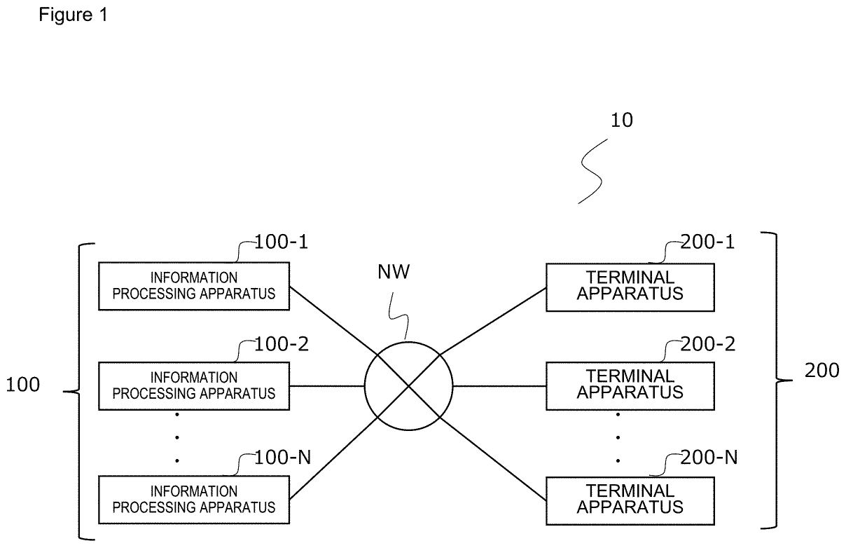

FIG. 1 is a configuration diagram illustrating an outline of an information processing system 10 according to an embodiment of the present disclosure. The information processing system 10 is constituted by including one or a plurality of information processing apparatuses 100 and one or a plurality of terminal apparatuses 200. In the example illustrated in FIG. 1, the number of information processing apparatuses 100 and terminal apparatuses 200 is N (N is an integer of 1 or more). The N information processing apparatuses 100 have a common configuration to each other, and are individually distinguished as information processing apparatuses 100-1 to 100-N. The N terminal apparatuses 200 have a common configuration to each other, and are individually distinguished as terminal apparatuses 200-1 to 200-N.

Each of the information processing apparatuses 100-1 to 100-N and the terminal apparatuses 200-1 to 200-N are communicably connected through a wired or wireless network NW. The network NW may be constituted by including a wide area network such as the Internet or a public wireless network as a part thereof, or may be constituted by including a local area network (LAN).

Note that, in the present description, when no distinction is to be made between the individual information processing apparatuses 100-1 to 100-N and the individual terminal apparatuses 200-1 to 200-N when describing matters that are common for the information processing apparatuses 100-1 to 100-N and for the terminal apparatuses 200-1 to 200-N, respectively, the apparatuses are referred to simply as “information processing apparatus 100” and “terminal apparatus 200”.

The information processing apparatus 100 is, for example, a server of a recipe website. On the other hand, the terminal apparatus 200 is a portable apparatus or a PC (personal computer) or the like, and for example, displays and browses a recipe website.

The information processing apparatus 100 stores recipe information posted from respective terminal apparatuses 200. Here, the recipe information represents a cooking method, and for example, includes various information such a user ID (represents a person who created (posted) the recipe or a person who prepared a dish with the recipe), a recipe name (dish name), a cooking process, ingredients, and cooking utensils.

Based on requests from the respective terminal apparatuses 200, the information processing apparatus 100 delivers some or all of the recipe information (including a list of recipe information; the same applies hereinafter) to the respective terminal apparatuses 200 to cause the respective terminal apparatuses 200 to display the recipe information. The respective terminal apparatuses 200 display the recipe information delivered from the information processing apparatus 100 on a display or the like.

With respect to each recipe information item or each dish (or genre) shown by the recipe information, the information processing apparatus 100 is capable of estimating and appropriately utilizing a cooking difficulty level for each individual user thereof. The information processing apparatus 100 acquires attributes, a cooking history, comments on recipes that were used and the like of the users which were input from the respective terminal apparatuses 200 or the like, and based on this information and recipe information as well as correspondence information that is described later, the information processing apparatus 100 estimates a cooking difficulty level, and outputs recipe information corresponding to the cooking difficulty level to the terminal apparatus 200 of the relevant user.

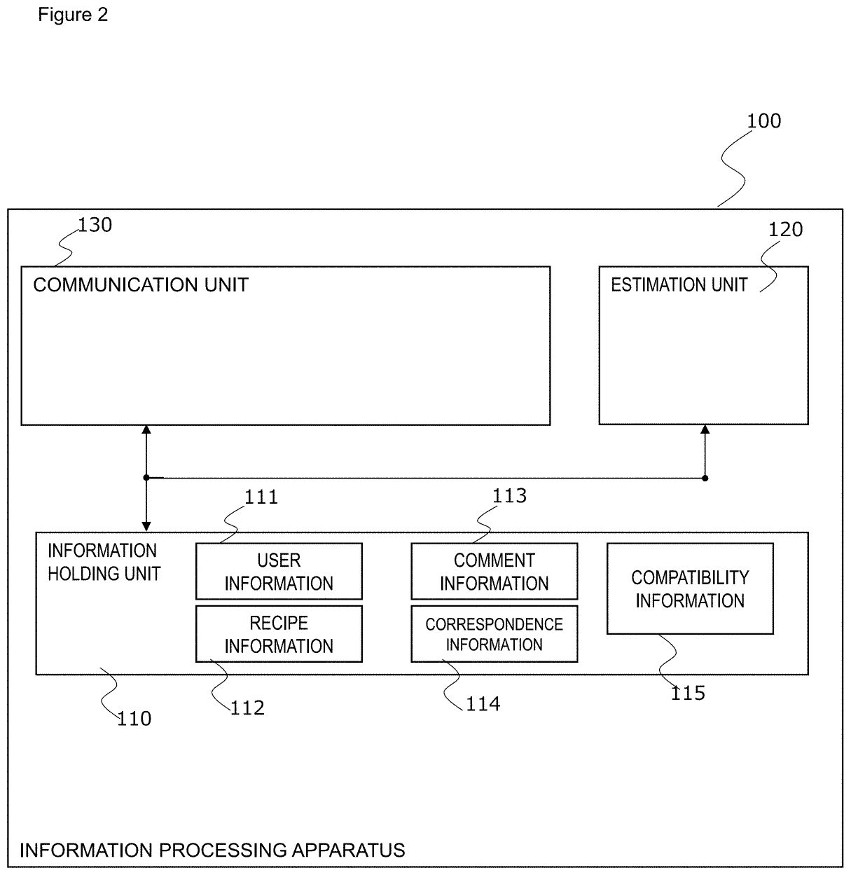

The information processing apparatus 100 is constituted, for example, by an information processing apparatus such as a computer or a mainframe. Further, as illustrated in FIG. 2, the information processing apparatus 100 is constituted by an information holding unit 110, an estimation unit 120, and a communication unit 130.

Among these, the information holding unit 110 stores user information 111, recipe information 112, comment information 113, correspondence information 114, and compatibility information 115.

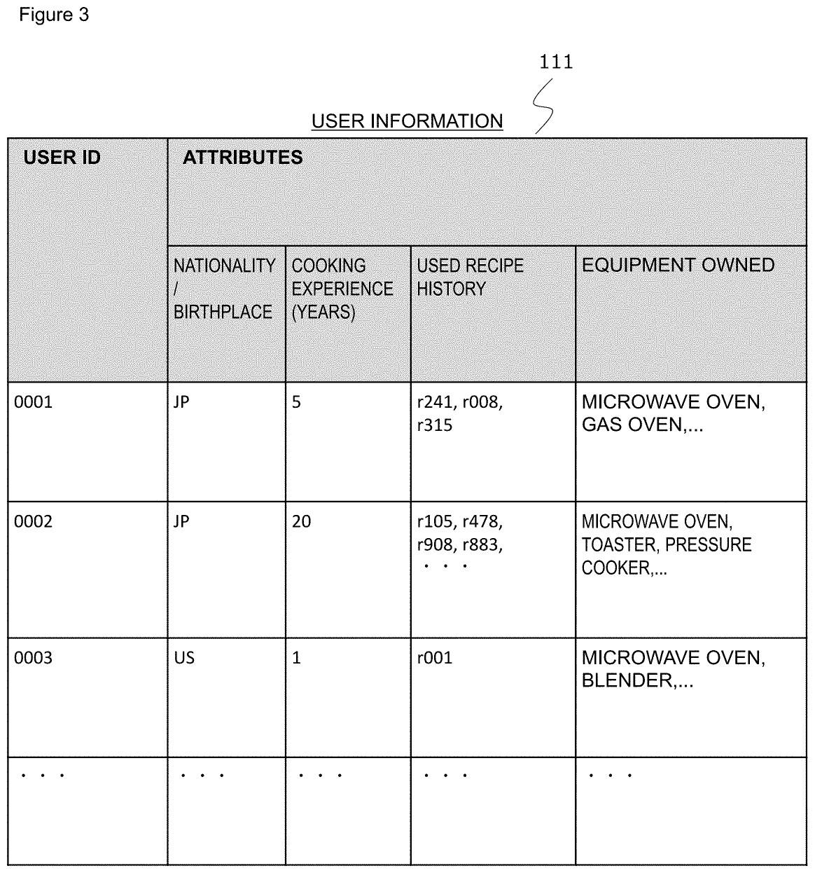

As illustrated in FIG. 3, the user information 111 is a table in which attribute information of a person who posts or uses recipe information is stored using the ID of the person, that is, a user ID, as a key. For example, attributes such as nationality or birthplace, number of years cooking experience, used recipe history, and equipment owned can be assumed as the attribute information that is stored here.

The aforementioned information regarding equipment owned may include cooking utensils and cooking tools that the user owns, as well as specification information pertaining to the cooking utensils and cooking tools. The specification information is, for example, information such as the amount of heat of a gas cooking appliance, the number of watts of a microwave oven, and the capacity or heat capacity of a pot. Note that, such specification information may be acquired by receiving an input from the user through the terminal apparatus 200, or may be acquired from product catalog information that a manufacturer of cooking equipment has made publically available on a website or the like. Alternatively, such specification information may be acquired by extracting the relevant information from keywords for cooking utensils and cooking tools which are described in recipe information that the relevant user used.

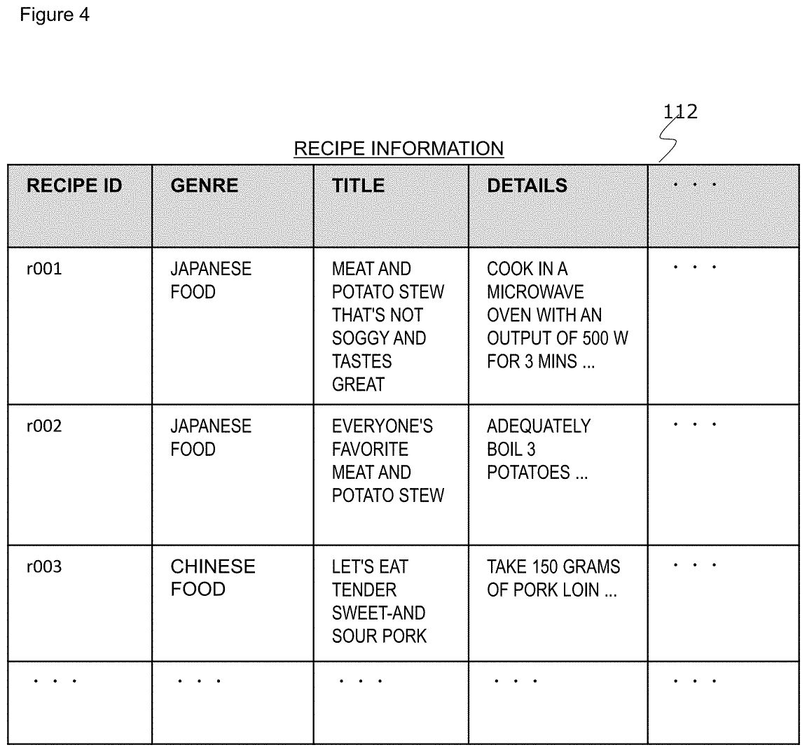

Further, as illustrated in FIG. 4, the recipe information is information for preparing a dish, and is a table in which, using a recipe ID that uniquely identifies a recipe as a key, information for each of the genre, title, and dish details is associated and stored. Among these, in the dish details, various kinds of information such as the ingredients, the equipment used, and the cooking operations are described for each cooking process. Note that, the recipe information may be content that is composed of images and text, or may be a moving image. The recipe information which the information processing apparatus 100 delivers may be posted by a user (a poster or a viewer) or may be posted by a service provider.

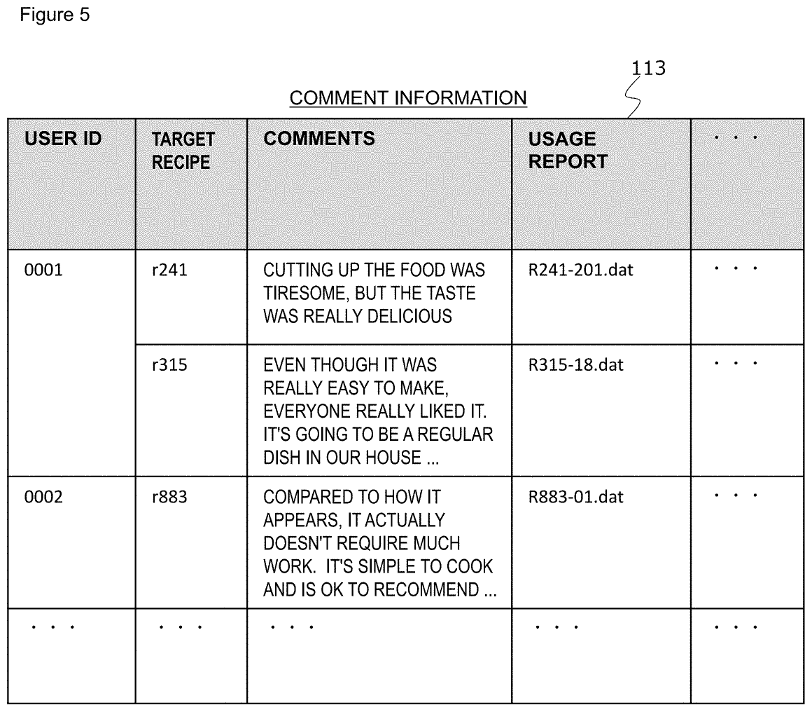

Further, the comment information 113 is a table that stores comments relating to recipe information published on the recipe website which are comments contributed (posted) by users who actually referred to the recipe information and cooked the relevant dish. As a specific example thereof, a record in which information such as comments and usage reports are associated using a user ID that uniquely identifies a user who posted a comment and a recipe ID of the recipe information that is the object of the post as a key is shown in FIG. 5.

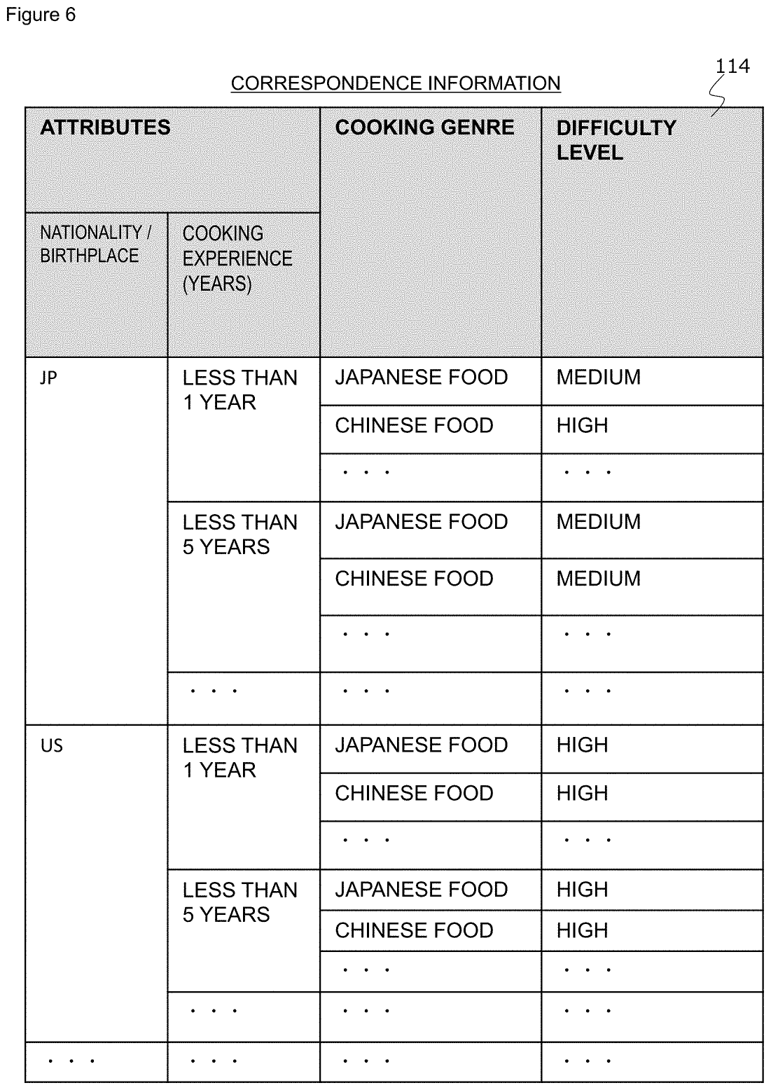

The correspondence information 114 is information that defines a relation between attributes of a person and a difficulty level of respective dishes. As shown in a specific example in FIG. 6, the correspondence information 114 is a collection of records that defines a difficulty level for each cooking genre for each pattern of nationality or birthplace and number of years cooking experience which are attributes of a person. In the example illustrated in FIG. 6, the difficulty level of each cooking genre such as Japanese food and Chinese food is defined based on the number of years cooking experience by nationality or birthplace.

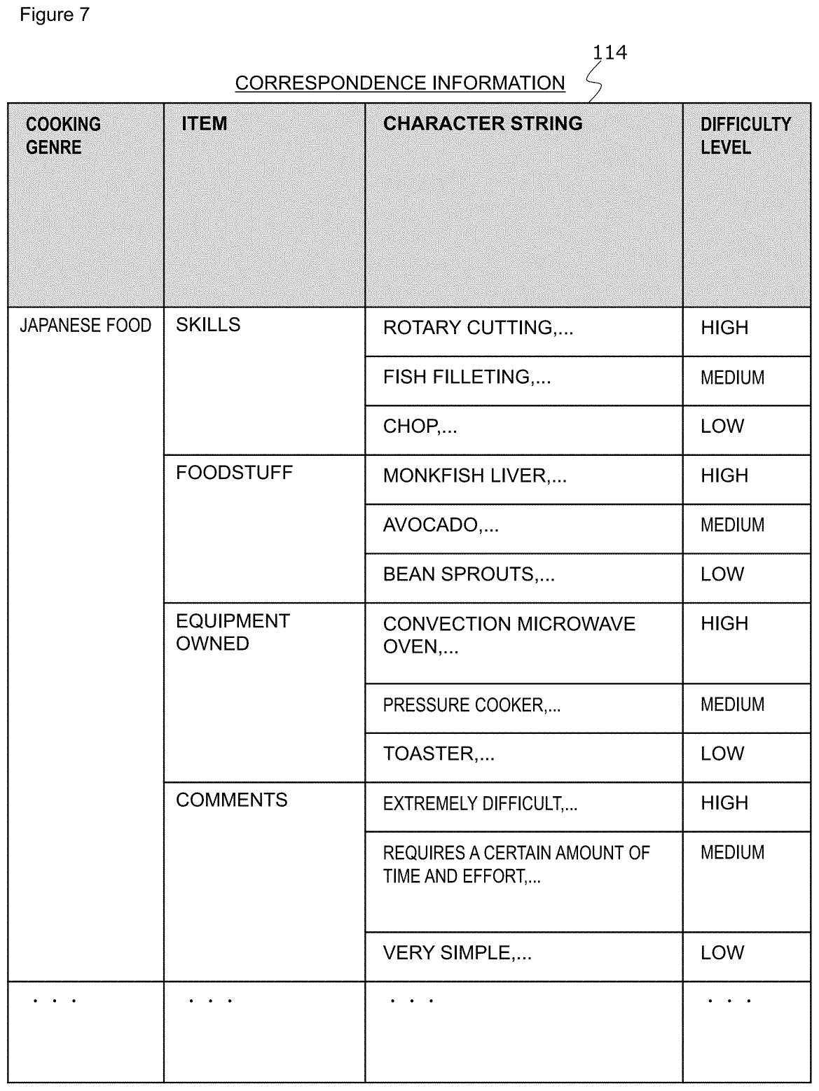

As illustrated in FIG. 7, the information holding unit 110 additionally holds, as further correspondence information 114, information that defines a relation between character strings and a difficulty level of each cooking genre. The correspondence information 114 in this case is information that, with respect to character strings relating to items such as skills, foodstuff, equipment owned, and comments for each cooking genre, defines a difficulty level in the relevant case in association with character strings. With regard to these character strings, both a case where character strings are included in descriptions of recipe information, and a case where character strings are included in comments or the like that users post on the recipe website can be assumed.

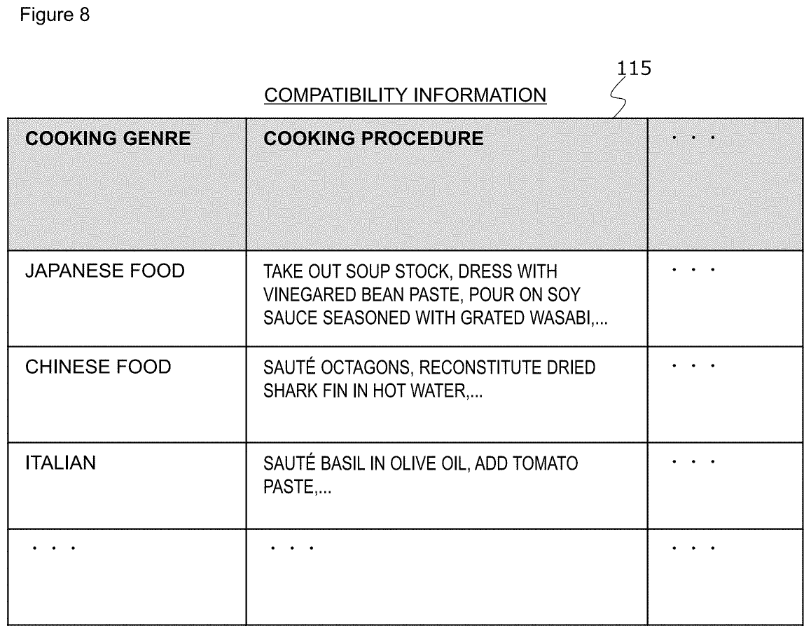

Further, as illustrated in FIG. 8, the compatibility information 115 is a table in which, for each cooking genre, respective cooking procedures which are estimated as being highly compatible with the relevant cooking genre are defined. The compatibility information 115 is information that the estimation unit 120 of the information processing apparatus 100 generates by, for each cooking genre, analyzing the appearance frequency of (keywords or phrases of) each cooking procedure that the recipe information for each dish includes, extracting a cooking procedure whose appearance frequency is equal to or higher than a predetermined criterion, and defining the compatibility between each genre and the relevant cooking procedure.

Further, the estimation unit 120 in the information processing apparatus 100 applies the nationality or birthplace of a user who uses (any recipe information among) the recipe information 112 held in the information holding unit 110, and information pertaining to the dish to be cooked using the relevant recipe information, that is, the genre, to the correspondence information 114, and estimates the difficulty level of the relevant recipe information for the relevant user.

Note that, the estimation unit 120 may extract, as the aforementioned information pertaining to the dish, a cooking time, cooking skills, cooking steps, a number of cooking steps, cooking utensils, or a number of cooking utensils in the recipe information 112, and apply the information and the attributes of the relevant user to the correspondence information 114 to estimate the difficulty level of the recipe information for the relevant user.

Furthermore, the estimation unit 120 may extract, as the aforementioned information pertaining to the dish, the ingredients, ingredients cost, a season when ingredients are in season, or distribution amount of ingredients in the recipe information 112, and apply the information and the attributes of the relevant user to the correspondence information 114 to estimate the difficulty level of the relevant recipe information for the relevant user.

Further, as already described above, the estimation unit 120 analyzes the appearance frequency of each cooking procedure that the recipe information 112 for each dish includes for each cooking genre, estimates the compatibility between each genre and the cooking procedure, and stores the result of the estimation in the information holding unit 110 as the compatibility information 115.

In this case, it is possible for the estimation unit 120 to extract information pertaining to cooking procedures from recipe information which a certain user will use, identify a genre having a predetermined compatibility with the relevant cooking procedure based on the result of the aforementioned estimation, that is, the compatibility information 115, and apply the genre and the nationality or birthplace of the user to the correspondence information 114 to estimate the difficulty level of the relevant recipe information for the user.

Further, the estimation unit 120 extracts comments by other users whose attributes (for example, nationality or birthplace, number of years cooking experience or the like) match or are similar to attributes of the user who is the object of the processing from the comment information 113, and based on character strings that the comments include and the correspondence information 114 (information illustrated in FIG. 7), estimates a difficulty level relating to the recipe information that is the subject of the comments as a common difficulty level for a user group of users who have the relevant attributes. In this case, for the aforementioned user who is the object of the processing, as the difficulty level of the recipe information that the user will use this time, the estimation unit 120 applies the difficulty level of the relevant recipe information estimated with respect to the user group (group of users whose attributes match or are similar) to which the user belongs.

Note that, a configuration may be adopted in which the estimation unit 120 estimates the technical ability of a user based on the user information 111 that indicates at least one of the attributes and an activity history of the user, and delivers recipe information to the terminal apparatus 200 of the relevant user based on information pertaining to each of the technical ability and a difficulty level already estimated.

Further, the communication unit 130 in the information processing apparatus 100 is a communication interface that conducts communication with the terminal apparatus 200 through the network NW. The communication unit 130 receives information such as the attributes, cooking history and comments and also recipe selection information of the relevant user which is transmitted from the terminal apparatus 200. Further, the communication unit 130 transmits recipe information and information pertaining to the cooking difficulty level to the terminal apparatus 200.

On the other hand, the terminal apparatus 200 displays the information transmitted from the information processing apparatus 100. The terminal apparatus 200 can also transmit information to the information processing apparatus 100.

The terminal apparatus 200 is an information processing apparatus such as a smartphone, a mobile phone, a PHS, a computer, a PDA, a wristwatch, a smartwatch, a head mounted display, or an image generating apparatus, and is an apparatus which is capable of connecting to the information processing apparatus 100 through the network NW such as the Internet (WAN) or a LAN. Note that, a connection between the terminal apparatus 200 and the information processing apparatus 100 may be a wired connection or a wireless connection.

Further, the terminal apparatus 200 may access the information processing apparatus 100 by means of dedicated application software installed in the terminal apparatus 200. Furthermore, the terminal apparatus 200 may access the information processing apparatus 100 by utilizing an operating environment (an API (application programming interface), a platform or the like) provided by the information processing apparatus 100 or a separate server (not illustrated).

### Flow of Processing

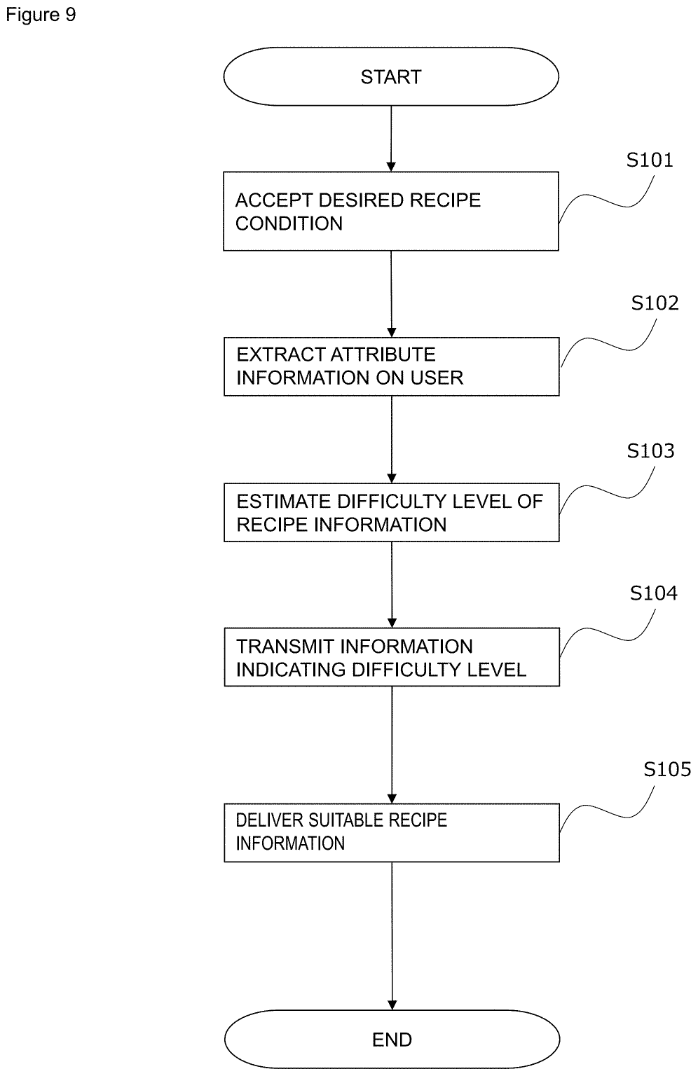

Next, operations of the information processing system 10 according to an embodiment of the present disclosure are described while referring to the flowchart shown in FIG. 9. The flowchart in FIG. 9 mainly shows operations performed by the information processing apparatus 100.

In step S101, the information processing apparatus 100, for example, receives input of a condition relating to a desired recipe from a terminal apparatus 200 which a user operates, and identifies recipe information that matches the condition from the recipe information 112. In this case, a condition such as a cooking genre or a dish name is assumed as the aforementioned condition which the user specified.

Further, in step S102, the information processing apparatus 100 extracts attribute information of the aforementioned user from the user information 111. If the user in this case is a registered user of the recipe website, it suffices for the information processing apparatus 100 to extract various kinds of attribute information such as the nationality or birthplace, number of years cooking experience, used recipe history, and equipment owned from the user information 111 by using the user ID of the user who is already logged in as a key.

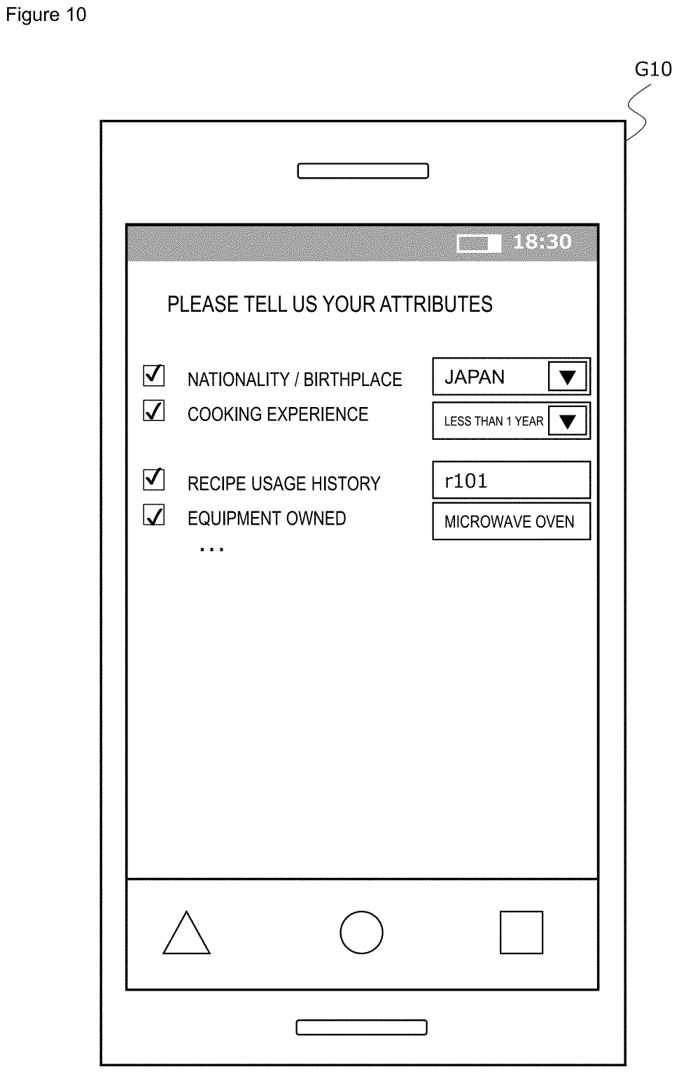

On the other hand, if the user is not a registered user, the information processing apparatus 100 may, for example, as illustrated in FIG. 10, deliver an attribute request screen G10 to the terminal apparatus 200, and acquire the same attribute information through this screen.

Further, in step S103, the information processing apparatus 100 estimates the difficulty level of the relevant recipe information for the user by applying the aforementioned attribute (for example, nationality or birthplace) of the user and information pertaining to a dish to be cooked using the recipe information, that is, the genre, to the correspondence information 114.

For example, it will be assumed here that the nationality or birthplace of the aforementioned user is “United States” (US), and the number of years cooking experience of the user is “less than 2 years”. Further, it will be assumed that the cooking genre of the recipe information that the user desires is “Chinese food”. In this case, in the correspondence information 114 illustrated in FIG. 6, the user with these attributes belongs to the category “less than 5 years” with respect to the number of years cooking experience, and the difficulty level is estimated as “high”.

Note that, the information processing apparatus 100 may be configured to estimate the difficulty level of the recipe information for the relevant user by, as the aforementioned information pertaining to the dish, in addition to the genre, extracting the cooking time, cooking skills, cooking steps, number of cooking steps, cooking utensils, or number of cooking utensils from the recipe information 112, and applying the relevant information and the attributes of the user to the correspondence information 114.

In this case, naturally, as the correspondence information 114, it is assumed that, for each cooking genre, a difficulty level is defined for each combination of the aforementioned cooking time, cooking skills, cooking steps, number of cooking steps, cooking utensils, and number of cooking utensils.

Further, the information processing apparatus 100 may be configured to extract the ingredients, ingredients cost, season when ingredients are in season, or amount in distribution from the recipe information 112 as the aforementioned information pertaining to the dish, and estimate the difficulty level of the recipe information for the relevant user by applying the relevant information and the attributes of the user to the correspondence information 114.

In this case also, naturally, as the correspondence information 114, it is assumed that, for each cooking genre, a difficulty level is defined for each combination of the aforementioned ingredients, ingredients cost, season when ingredients are in season, and amount in distribution.

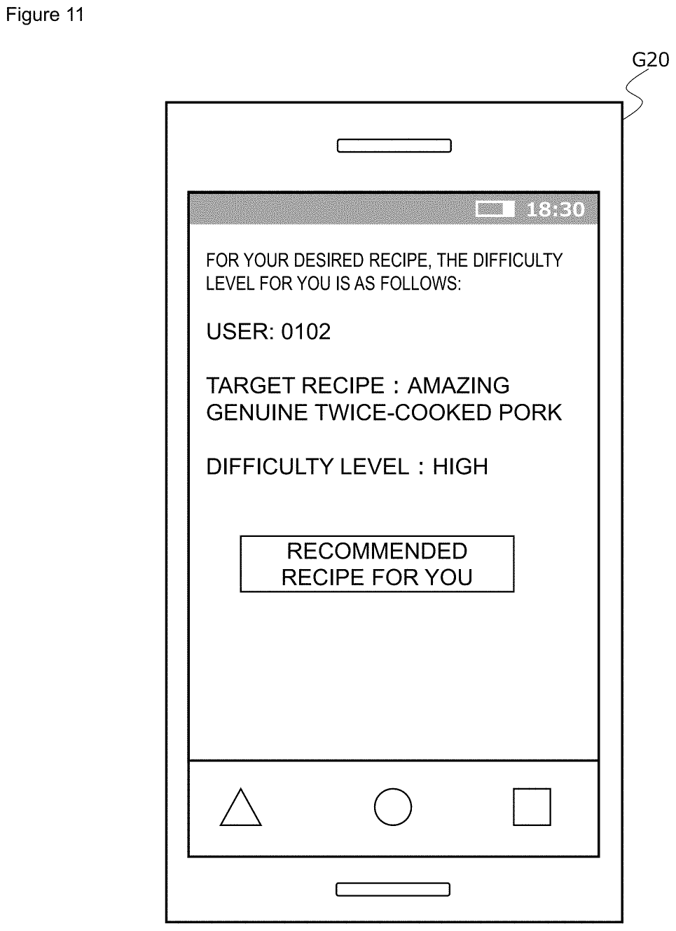

Further, in step S104, the information processing apparatus 100 delivers information on the difficulty level estimated in the aforementioned S103 to the terminal apparatus 200 of the user of the relevant recipe information as shown on a screen G20 illustrated in FIG. 11.

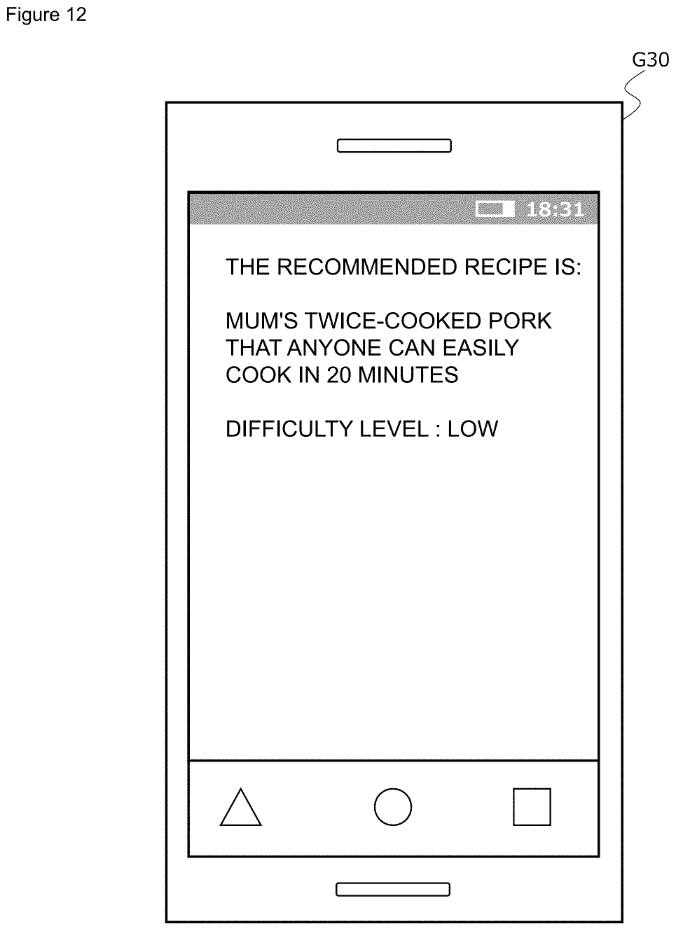

Further, a configuration may be adopted so that, in step S105, the information processing apparatus 100 estimates the technical ability of the user based on the user information 111 that indicates at least one of the attribute information of the user as described above and the activity history (recipe usage history), and delivers recipe information (see screen G30 in FIG. 12) to the terminal apparatus 200 of the user based on information pertaining to each of the technical ability and the difficulty level already estimated.

For example, in the case of a user whose attribute for nationality or birthplace is “United States” (US) and whose attribute for number of years cooking experience is “less than 2 years”, and who has a used recipe history of “10 recipes or more” in the “Chinese food” genre as their activity history, although the difficulty level of the desired recipe would be “high” if estimated based on only the attributes, taking into account the fact that the user is appropriately familiar with recipe information for Chinese food, the difficulty level of the relevant recipe is determined as being “medium”, and another recipe (a different recipe which did not receive any hits under the initially desired condition) for which the difficulty level is “medium” for the relevant user (or other users having attributes which match or are similar to the attributes of the relevant user) is delivered to the terminal apparatus 200 of the relevant user.

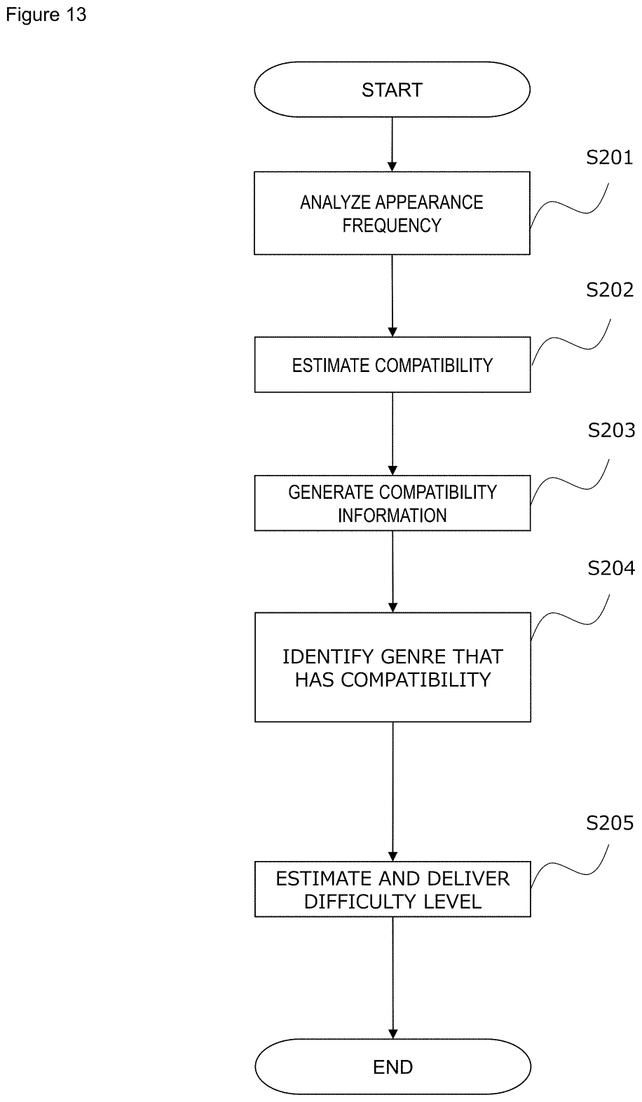

Further, as illustrated in the flowchart in FIG. 13, the information processing apparatus 100 generates the compatibility information 115 in advance separately to the flowchart in FIG. 9 that is described above. In this case, in step S201, the information processing apparatus 100 refers to the recipe information 112 in the information holding unit 110, and for each cooking genre in the recipe information 112, analyzes the appearance frequency of each cooking procedure that the recipe information for each dish includes.

In this analysis, first, the information processing apparatus 100 performs a morphological analysis with respect to the text data of the contents of the recipe information, and extracts phrases. Further, among these phrases, phrases for which a hit is obtained in a cooking procedure dictionary (a dictionary of sentences describing cooking procedures, which is prepared in advance and held) are specified as descriptions of cooking procedures. The information processing apparatus 100 then calculates the frequency probability for each specified cooking procedure by calculating how often the description of each specified cooking procedure appears in the recipe information of each cooking genre.

In step S202, for each cooking genre, the information processing apparatus 100, for example, identifies a description of a cooking procedure having an appearance frequency which is higher than the appearance frequency average among the cooking procedures, and estimates that the cooking procedure in question has high compatibility with the relevant cooking genre.

In step S203, the description of the cooking procedure estimated to have high compatibility is associated with the corresponding cooking genre by the information processing apparatus 100, and stored as the compatibility information 115. In this way, the compatibility information 115 is generated.

In this case, in step S204, the information processing apparatus 100 extracts information pertaining to a cooking procedure from recipe information which is to be used by a certain user in a similar manner to the manner described above, and identifies a cooking genre having a predetermined compatibility with the relevant cooking procedure based on the compatibility information 115.

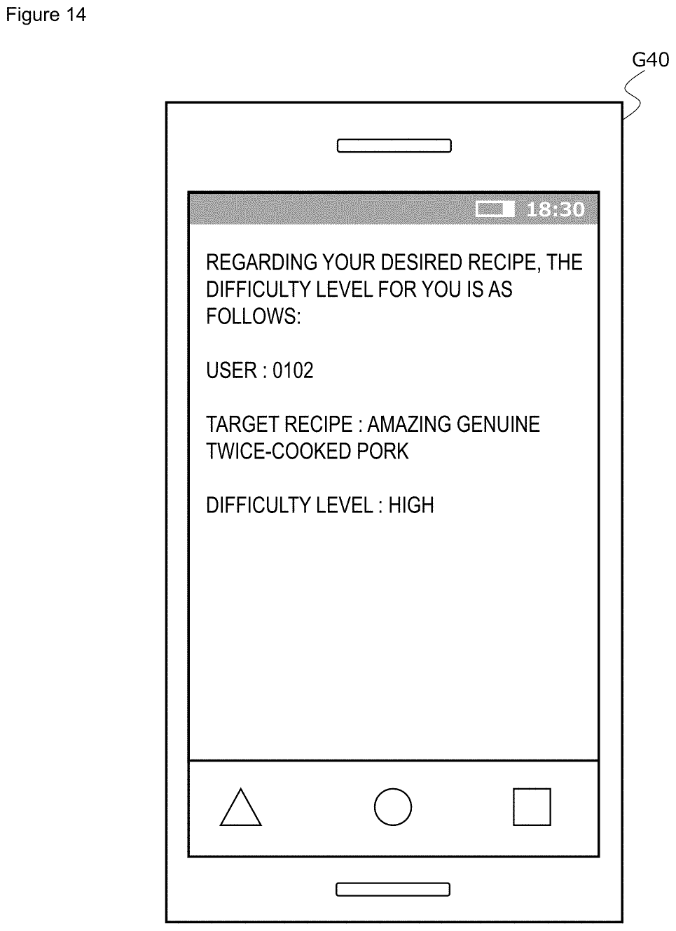

Next, in step S205, the information processing apparatus 100 applies the identified cooking genre and attribute information such as the nationality or birthplace of the user to the correspondence information 114 to estimate the difficulty level of the relevant recipe information for the user, and delivers information on the difficulty level to the terminal apparatus 200 (screen G40 in FIG. 14).

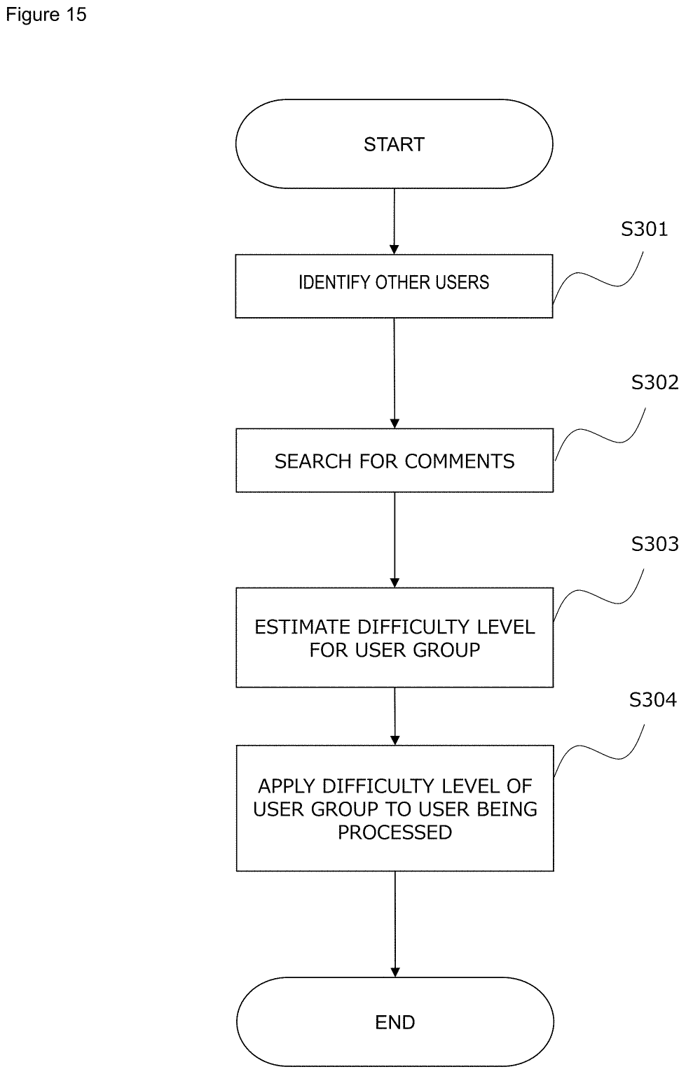

Note that, as illustrated in the flowchart in FIG. 15, the information processing apparatus 100 may be configured to apply a difficulty level that is common for a group of other users whose attributes (for example, nationality or birthplace, number of years cooking experience, or the like) match or are similar to the attributes of the user who is the object of the processing as the difficulty level for the relevant user.

In this case, in step S301, the information processing apparatus 100 uses the user information 111 to identify other users whose attributes (for example, nationality or birthplace, number of years cooking experience, or the like) match or are similar to the attributes of the user who is the object of the processing.

Next, in step S302, the information processing apparatus 100 searches the comment information 113 for comments regarding recipe information of each cooking genre posted by the other users identified in 5301.

Further, in step S303, the information processing apparatus 100 extracts character strings from the comments by other users retrieved in relation to the recipe information of each cooking genre, and by comparing the extracted character strings with the correspondence information 114 (information illustrated in FIG. 7), estimates a common difficulty level with respect to the relevant cooking genre or the relevant recipe information for the user group that has the relevant attribute.

For example, with respect to predetermined recipe information of the cooking genre “Japanese food”, by comparing the character strings (for example, rotary cutting, monkfish liver, pressure cooker, and requires a certain amount of time and effort) obtained from comments by other users with the correspondence information 114 in FIG. 7, the information processing apparatus 100 obtains values for a difficulty level for the respective character strings. The information processing apparatus 100 adopts the most frequent difficulty level value among the difficulty level values obtained in this way as the difficulty level for the aforementioned user group with respect to the relevant recipe information of the relevant cooking genre.

Further, in step S304, as the difficulty level of the recipe information (recipe information used this time) desired by the user who is the object of the aforementioned processing, the information processing apparatus 100 applies the difficulty level of the relevant recipe information estimated in S303 with respect to the user group (group of users having matching or similar attributes) to which the relevant user belongs. Naturally, the information processing apparatus 100 may be configured to search the recipe information 112 of the information holding unit 110 for recipe information corresponding to the difficulty level obtained in this way, and deliver the information to the terminal apparatus 200 of the relevant user.

As described above, the information processing apparatus 100 according to an embodiment of the present disclosure holds the correspondence information 114 that defines a relation between attributes of a person and a difficulty level of respective dishes, and the recipe information 112 for respective dishes in the information holding unit 110, and by applying attributes of a user of the recipe information 112 and information pertaining to a dish to be cooked using the relevant recipe information 112 to the correspondence information 114, the information processing apparatus 100 can estimate a difficulty level of the recipe information 112 for the relevant user. From the point of view of a user, this means that it is possible to know the difficulty level that matches the individual circumstances of the user without worrying that there may be a discrepancy between the difficulty level considered by the recipe creator and the difficulty level for the relevant user. Hence, it is possible to accurately estimate the cooking difficulty level of a recipe for each user.

### Program

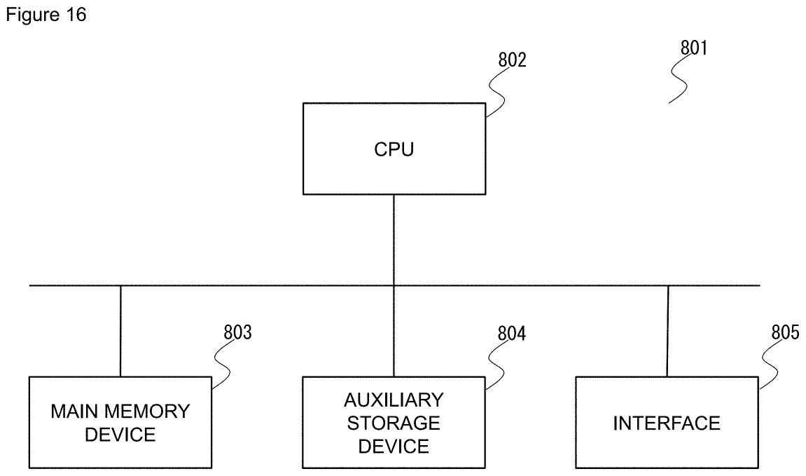

FIG. 16 is a schematic block diagram illustrating the configuration of a computer 801. The computer 801 includes a CPU 802, a main memory device 803, an auxiliary storage device 804, and an interface 805.

Here, details of a program for realizing respective functions constituting the information processing apparatus 100 according to the embodiment will be described.

The information processing apparatus 100 is mounted in the computer 801. In addition, operations of respective constituent elements of the information processing apparatus 100 are stored in the auxiliary storage device 804 in a program format. The CPU 802 reads out the program from the auxiliary storage device 804 and develops the program in the main memory device 803, and executes the above-described processing in accordance with the program. In addition, the CPU 802 secures a storage region corresponding to the above-described storage section in the main memory device 803 in accordance with the program.

Specifically, the program is a program for causing the computer 801 to execute processing to hold correspondence information that defines a relation between attributes of a person and a difficulty level of respective dishes, and recipe information for respective dishes, and to apply attributes of a user of the recipe information and information pertaining to a dish to be cooked using the recipe information to the correspondence information to estimate a difficulty level of the recipe information for the user.

Note that, the auxiliary storage device 804 is an example of a non-transitory tangible medium. Other examples of the non-transitory tangible medium that may be mentioned include a magnetic disk, a magneto-optical disk, a CD-ROM, a DVD-ROM, a semiconductor memory, and the like which are connected via the interface 805. In addition, in a case where the program is delivered to the computer 801 via the network NW, upon receiving the delivered program, the computer 801 may expand the program in the main memory device 803 and execute the above-described processing.

Further, the program may be configured to implement some of the above-described functions. In addition, the program may be a program which implements the above-described functions in combination with other programs that have been already stored in the auxiliary storage device 804, that is, a so-called difference file (difference program).

Whilst several embodiments of the present disclosure have been described above, these embodiments can be implemented in a variety of other forms, and various omissions, substitutions and changes in the form of the embodiments described herein may be made without departing from the gist of the invention. These embodiments and the modifications thereof are included within the scope and gist of the invention, and are also included in the scope of the inventions described in the accompanying claims and their equivalents.

### REFERENCE SIGNS LIST

10 Information processing system

100 Information processing apparatus

110 Information holding unit

111 User information

112 Recipe information

113 Comment information

114 Correspondence information

115 Compatibility information

120 Estimation unit

130 Communication unit

200 Terminal apparatus

801 Computer

802 CPU

803 Main memory device

804 Auxiliary storage device

805 Interface

1. An information processing system comprising a processor and a memory with instructions thereon, wherein:
the memory holds correspondence information that defines a relation between attributes of a person and a difficulty level of respective dishes, and recipe information for respective dishes; and
the instructions upon execution by the processor, cause the processor to estimate a difficulty level of the recipe information for a user of the recipe information by applying attributes of the user and information pertaining to a dish to be cooked using the recipe information to the correspondence information.

2. The information processing system according to claim 1, wherein:
the memory holds, as the correspondence information, information that defines a relation between a nationality or a birthplace that is one of the attributes of the person, and a difficulty level of a genre of the respective dishes; and
the instructions upon execution by the processor, cause the processor to estimate a difficulty level of the recipe information for the user by applying a nationality or a birthplace of a user who uses the recipe information, and a genre of a dish to be cooked using the recipe information to the correspondence information.

3. The information processing system according to claim 2, wherein the instructions upon execution by the processor, cause the processor to:
analyze, for each cooking genre, an appearance frequency of each cooking procedure that the recipe information for the respective dishes includes, estimate a compatibility between each genre and cooking procedures, and stores a result of the estimation in the memory; and
extract information pertaining to a cooking procedure from the recipe information that the user uses, identify a genre having a predetermined compatibility with the cooking procedure based on the result of the estimation, and apply the genre and a nationality or a birthplace of the user to the correspondence information to estimate a difficulty level of the recipe information for the user.

4. The information processing system according to claim 1, wherein:
the memory further holds comments relating to the recipe information by respective users of respective items of recipe information, and information which defines a relation between character strings and a difficulty level of respective dishes and which is one item of the correspondence information; and
the instructions upon execution by the processor, cause the processor to further perform processing that extracts the comments by other users whose attributes match or are similar to attributes of the user of the recipe information, and based on character strings that the comments include and the correspondence information, estimates a difficulty level relating to recipe information that is a subject of the comments as a common difficulty level for a user group of users who have the attributes, and processing that applies a difficulty level of the recipe information which is estimated with respect to a user group to which the user belongs as a difficulty level of the recipe information for the user.

5. The information processing system according to claim 1, wherein the instructions upon execution by the processor, cause the processor to estimate a technical ability of a user based on user information that indicates at least one of an attribute and an activity history of the user, and present the recipe information to the user based on the estimated difficulty level and information pertaining to the technical ability.

6. The information processing system according to claim 1, wherein the instructions upon execution by the processor, cause the processor to extract, from the recipe information, a cooking time, cooking skills, cooking steps, a number of cooking steps, cooking utensils, or a number of cooking utensils as the information pertaining to a dish, and apply the information and attributes of the user to the correspondence information to estimate a difficulty level of the recipe information for the user.

7. The information processing system according to claim 1, wherein the instructions upon execution by the processor, cause the processor to extract, from the recipe information, ingredients, an ingredients cost, a season when ingredients are in season, or distribution amount of ingredients as the information pertaining to a dish, and apply the information and attributes of the user to the correspondence information to estimate a difficulty level of the recipe information for the user.

8. An information processing apparatus comprising a processor and a memory with instructions thereon, wherein:
the memory holds correspondence information that defines a relation between attributes of a person and a difficulty level of respective dishes, and recipe information for respective dishes; and
the instructions upon execution by the processor, cause the processor to estimate a difficulty level of the recipe information for a user of the recipe information by applying attributes of the user and information pertaining to a dish to be cooked using the recipe information to the correspondence information.

9. An information processing method, the method comprising causing an information processing apparatus to:
hold correspondence information that defines a relation between attributes of a person and a difficulty level of respective dishes, and recipe information for respective dishes; and
estimate a difficulty level of the recipe information for a user of the recipe information by applying attributes of the user and information pertaining to a dish to be cooked using the recipe information to the correspondence information.
